(19) United States
(12) Patent Application Publication
(10) Pub. No.: US 2012/0271806 A1
(43) Pub. Date: Oct. 25, 2012

(54) GENERATING DOMAIN-BASED TRAINING DATA FOR TAIL QUERIES

(75) Inventors: Samuel Ieong, Mountain View, CA (US); Nina Mishra, Pleasanton, CA (US); Eldar Sadikov, Menlo Park, CA (US); Li Zhang, Sunnyvale, CA (US)

(73) Assignee: Microsoft Corporation, Redmond, WA (US)

(21) Appl. No.: 13/091,145

(22) Filed: Apr. 21, 2011

(51) Int. Cl. G06F 17/30

(52) U.S. Cl. 707/706; 707/E17.108

(57) ABSTRACT

Training data is provided for tail queries based on a phenomena in search engine user behavior—referred to herein as “domain trust”—as an indication of user preferences for individual URLs in search results returned by a search engine for tail queries. Also disclosed are methods for generating training data in a search engine by forming a collection of query+URL pairs, identifying domains in the collection, and labeling each domain. Other implementations are directed ranking search results generated by a search engine by measuring domain trust for each domain corresponding to each URL from among a plurality of URLs and then ranking each URL by its measured domain trust.

### BACKGROUND

It has become common for users of computers connected to the World Wide Web (the “web”) to employ web browsers and search engines to locate web pages (or “documents”) having specific content of interest to them (the users). A web-based commercial search engine may index tens of billions of web documents maintained by computers all over the world. Users of the computers compose queries, and the search engine identifies documents that match the queries to the extent that such documents include key words from the queries (known as the search results or result set).

However, like any large database, the web contains many low quality documents as well as many seemingly related but entirely irrelevant documents to specific user queries. As a result, naïve search engines may return hundreds of irrelevant or unwanted documents that tend to bury (or exclude altogether) the few relevant ones the user is actually seeking. Consequently, web-based commercial search engines employ various techniques that attempt to present more relevant documents to user search queries. Unfortunately, the substantial success of these various approaches has been largely limited to common queries that, for example, may comprise only a few search terms (referred to as “head queries”) yet, in contrast, much work is needed to improve results for rare searches that may, for example, comprises many uncommon search terms (referred to as “tail queries”).

### SUMMARY

Various implementations disclosed herein are directed to providing training data for tail queries based on a phenomena in search engine user behavior—referred to herein as “domain trust”—as an indication of user preferences for individual uniform resource locators (URLs) in search results returned by a search engine for tail queries.

Several implementations are directed to methods for generating training data in a search engine by forming a collection of query+URL pairs, identifying domains in the collection, and labeling each domain (which may include labeling each URL corresponding to each domain) from among the domains present in the collection. Other implementations are directed to systems for ranking search results generated by a search engine wherein the search results comprise URLs, the system comprising a subsystem for measuring domain trust for each domain corresponding to each URL from among the URLs, and a subsystem for ranking each URL from among the URLs by its measured domain trust.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

To facilitate an understanding of and for the purpose of illustrating the present disclosure and various implementations, exemplary features and implementations are disclosed in, and are better understood when read in conjunction with, the accompanying drawings—it being understood, however, that the present disclosure is not limited to the specific methods, precise arrangements, and instrumentalities disclosed. Similar reference characters denote similar elements throughout the several views. In the drawings:

FIG. 1 is an illustration of a search engine in an exemplary network environment in which the numerous implementations disclosed herein may be utilized;

FIG. 2 is a process flow diagram of a method, representative of several implementations disclosed herein, for inducing a scoring function for a search engine using training data;

FIG. 3 is a process flow diagram of a method, representative of several implementations disclosed herein, for measuring domain trust based onClickSkip data; and

FIG. 4 shows an exemplary computing environment.

### DETAILED DESCRIPTION

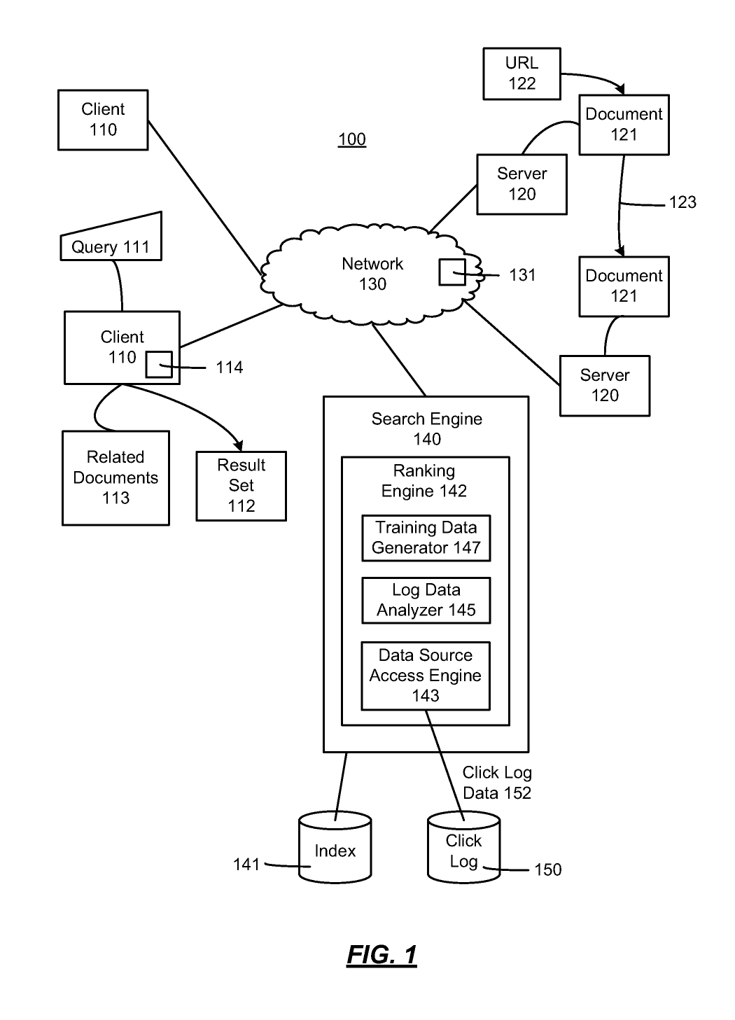

FIG. 1 is an illustration of a search engine 140 in an exemplary network environment 100 in which the numerous implementations disclosed herein may be utilized. The environment includes one or more client computers 110 and one or more server computers 120 (generally “hosts”) connected to each other by a network 130, for example, the Internet, a wide area network (WAN) or local area network (LAN). The network 130 provides access to services such as the World Wide Web (the “web”) 131.

The web 131 allows the client computer(s) 110 to access documents 121 containing text or multimedia and maintained and served by the server computer(s) 120. Typically, this is done with a web browser application program 114 executing on the client computer(s) 110. The location of each of the documents 121 may be indicated by an associated uniform resource locator (URL) 122 that is entered into the web browser application program 114 to access the document 121 (and thus the document and the URL for that document may be used interchangeably herein without loss of generality). Many of the documents may include hyperlinks 123 to other documents 121 (with each hyperlink in the form of a URL to its corresponding document).

In order to help users locate content of interest, a search engine 140 may maintain an index 141 of documents in a memory, for example, disk storage, random access memory (RAM), or a database. In response to a query 111, the search engine 140 returns a result set 112 that satisfies the terms (e.g., the keywords) of the query 111. Because the search engine 140 stores many millions of documents, the result set 112 may include a large number of qualifying documents, particularly when the query 111 is loosely specified. Unfortunately, these documents may or may not be related to the user's actual information needs. Therefore, the order in which the result set 112 is presented to the client 110 can affect the user's experience with the search engine 140.

For various implementations disclosed herein, a ranking process may be implemented as part of a ranking engine 142 within the search engine 140. The ranking process may be based upon a click log 150 to improve the ranking of documents in the result set 112 so that documents 113 related to a particular topic may be more accurately identified. Although only one click log 150 is shown, any number of click logs may be used with respect to the techniques and aspects described herein. Documents that are usually clicked may be considered more relevant than documents that are usually skipped.

For each query 111 that is posed to the search engine 140, the click log 150 may comprise the query 111 posed, the time at which it was posed, a number of documents shown to the user (e.g., ten documents, twenty documents, etc.) as the result set 112, the URLs of the documents shown to the user, and the document (and URL) from the result set 112 that was clicked by the user. Clicks may be combined into sessions and may be used to deduce the sequence of documents clicked by a user for a given query. The click log 150 may thus be used to automatically deduce human judgments as to the relevance of particular documents. The click log 150 may then be interpreted and used to generate training data that may be used by the search engine 140 where higher quality training data provides better ranked search results. The documents clicked as well as the documents skipped by a user may be used to assess the relevance of a document to a query 111.

Labels for training data may be generated based on data from the click log 150 to improve search engine relevance ranking, and aggregating clicks of multiple users can provide a better relevance determination than a human judge (or panel of human judges) since a user generally has some knowledge of the query and the multiple users that click on a particular search result bring diversity of opinion and a natural consensus. Moreover, when click data from multiple users is considered, specialization and a draw on local knowledge may be obtained—as opposed to a human judge who may or may not be knowledgeable about the query and may have no knowledge of the result of a query—and the quality of each rating improves because users who pose a query out of their own interest are more likely to be able to assess the relevance of documents presented as the results of the query. In addition to quality improvements, automation using click logs is more efficient and economical and can process many more queries than human judges, which can be used for scalability.

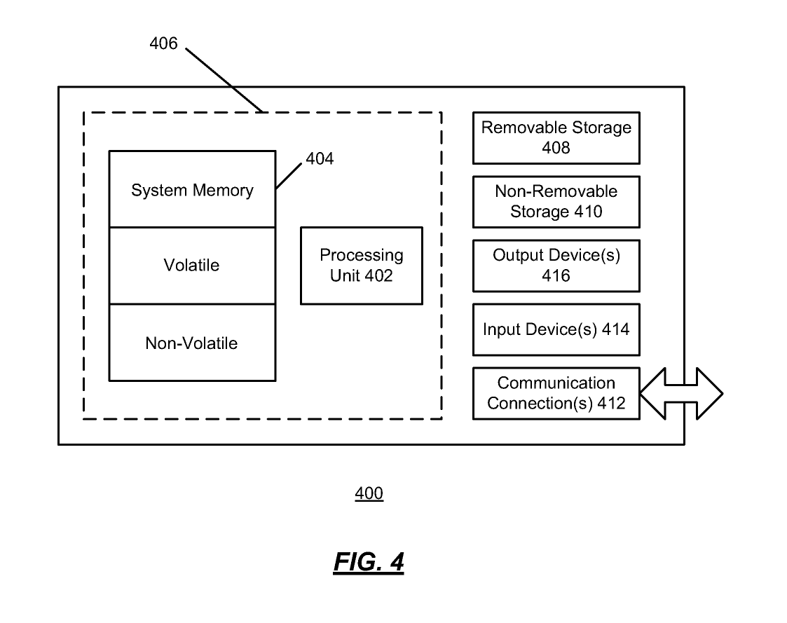

The ranking engine 142 may comprise a log data analyzer 145 and a training data generator 147. The log data analyzer 145 may receive click log data 152 from the click log 150, e.g., via a data source access engine 143. The log data analyzer 145 may analyze the click log data 152 and provide results of the analysis to the training data generator 147. The training data generator 147 may use tools, applications, and aggregators, for example, to determine the relevance or label of a particular document based on the results of the analysis, and may apply the relevance or label to the document, as described further herein. The ranking engine 142 may comprise a computing device which may comprise the log data analyzer 145, the training data generator 147, and the data source access engine 143, and may be used in the performance of the techniques and operations described herein. An example computing device is described with respect to FIG. 4.

To provide a high-quality user experience, search engines order search results using a ranking function that, based on the query and for each document in the search results, produces a score indicating how well the document matches the query. In some instances, this ranking may be based on the results of a machine learning algorithm that receives as input a set of training data comprising a collection of query and URL (query+URL) pairings (or “pairs”) that have each been given a relevance label (e.g., perfect, excellent, good, fair, bad, etc.) indicating how well the particular document matches the particular query. Each “triplet” of training data (query, document, and label) is then converted into a feature vector by the machine learning algorithm and collectively this training data is used to induce a function to score and rank search results generated by the search engine in response to real-time user queries. As will be appreciated, different labeling structures and schemes—such as, for example, a 1-10 scale or one with logarithmic steps between consecutive labels—may be used based on the capabilities of the machine learning algorithm, and such alternatives can be used without any loss of generality with regard to the implementations disclosed herein.

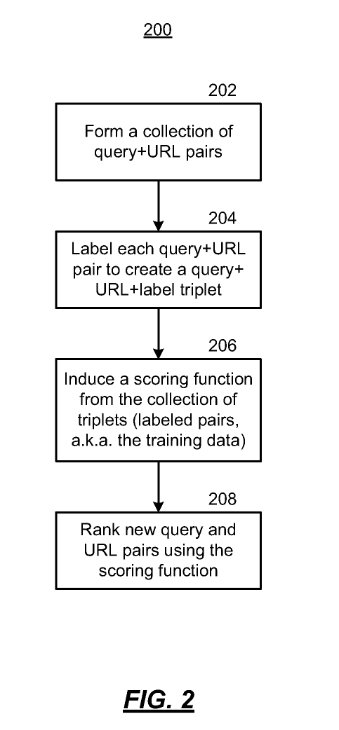

FIG. 2 is a process flow diagram of a method 200, representative of several implementations disclosed herein, for inducing a scoring function for a search engine using training data. Referring to FIG. 2, and at 202, a collection of query+URL pairs is formed. At 204, each query+URL pair is labeled (e.g., perfect, excellent, good, fair, bad, etc.) based on how well the particular document matches the particular query for that pair. The labeled pair now comprises a triplet, i.e., query+URL+label, and constitutes a single training data entry. At 206, the triplets are provided to a machine learning algorithm to induce (or “learn”) a scoring function. At 208, the scoring function is used to determine scores for new query and URL pairs, namely the search results returned by a search engine in response to a user query.

While the collection of query+URL pairs at 202 can be formed by any of several known methods—such as custom-crafting the collection to include specific queries matched to certain documents—an implementation may use the query+URL information stored in the click logs of a search engine.

Labeling these query+URL pairs at 204 is more challenging. One approach to labeling pairs in a collection is to do so using a human judge (or a panel of human judges), essentially acting as a surrogate for a search engine user, to review each query+URL pair and determine the correct label to apply (or, for a panel of judges, to aggregate the votes of individual judges to determine the correct label to apply). However, using human judges is time-consuming, costly, and difficult to scale to meet the increasing demand for generating training data, and these challenges are multiplied by the need to keep training data (and its labels) timely and current which would mean reprocessing query+URL pairs over and over again. Moreover, with specific regard to tail queries (compared to head queries), human judges are also less likely to be knowledgeable of the topics pertaining to these rarer (possibly lengthier, more specific, and/or more technical) queries which in turn can lead to unreliable labeling results.

For these and other reasons, it is often preferable to instead use an automated method for labeling query+URL pairs in lieu of human judges. One automated approach is to again use the click logs which not only contain a record of all user queries posed to a search engine and the URLs that were provided to the user by the search engine in response to that query but also (as the name suggests) a record of which query+URL pairs were selected (or “clicked”) and which query+URL pairs were not selected (or “skipped”). Based on the presumption that a user is likely to click on the most relevant URL(s) to the query and skip (i.e., not click) the URL(s) that are not the most relevant, aggregating the activities of many users generating many instances of query+URL pairs (some unique but many repeated often by the population of search engine users) provides a useful signal about the quality for certain query+URL pairs that, in turn, can be used for automatically generating labels for such query+URL pairs. However, to be effective these automated methods require a relatively large number of instances for each unique query+URL pair. While this is not a problem for head queries (which are frequently used and thus have a lot of instances with click/skip data), these automated approaches are ineffective for tail queries which by their very nature (i.e., their rarity of occurrence) lack enough click data to produce meaningful click-based labeling results.

Thus, while commercial search engines are able to provide high-quality results for head queries, the lack of good training data is one of the reasons search engines do not provide high-quality results for tail queries. Consequently, much improvement is needed in ranking the search results for tail queries.

Various implementations disclosed herein, however, are directed to methods for providing training data for tail queries. Several of these implementations are based on a phenomena in search engine user behavior—referred to herein as “domain trust”—which can provide an indication of user preferences for individual URLs in search results returned by a search engine for a tail query. These user preferences are based on the domain of a URL, and these user preferences provide a good surrogate for the relevance of the document corresponding to such a URL.

More specifically, “domain trust” is the observed and demonstrated phenomena that users prefer search results from certain domains over search results from other domains, and that users tend to click on certain domains with a consistency that overcomes position bias and other influences present in the display of search engine results. As used herein, “domain” refers to the domain name or portion of a URL corresponding to the hostname typically issued to a specific entity by a domain name registrar. For example, the domain portion (or just “domain”) of the URL <http://microsoft.com/default.aspx> and the URL <http://research.microsoft.com/en-us/people/hangli/xu-etal-wsdm2010.pdf> are <microsoft.com>, while the remainder of each URL would be a “non-domain” portion.

To understand domain trust, it is useful to discuss “branding.” Branding is a foundational marketing concept where a “brand” is the identity of a specific product, service, or business as it exists in the minds of consumers based on expectations and user experience—that is, a brand is an impression associated with a product or service regarding the qualities or characteristics that make the products and services special, unique, or desirable. Brand preference (brand loyalty) is the existence of consumer commitment to a brand based on trust stemming from positive or consistent experience with the products of that brand. Brand loyalty is manifested as repeated purchasing or using of the brand's product or service. While some customers may repurchase or repeatedly use a brand due to situational constraints, a lack of viable alternatives, or out of convenience (sometimes referred to as “spurious loyalty”), true brand loyalty exists when customers have a high relative attitude toward the brand (e.g., trust) which is then exhibited through unconstrained repurchase or repeat-use behavior. As such, these customers may also be willing to pay higher prices for the brand, may cost less to serve, and may even bring new customers to the brand.

In contrast, search engine results—and the ranked order in which those results are presented—are widely believed to determine which links a user will select (or click). However, if users had no intrinsic preference for domains, then changes in the top displayed results should lead to corresponding changes in the clicked results regardless of the domains, and this has not been the case. On the contrary, empirical evidence suggests that users actually click on the same domains despite changes in surfaced content, and that over time the top domains have been garnering a larger and larger percentage of all user clicks—trends that stand in stark contrast to the growing size of the web content and increasing number of registered domains. Stated differently, this data suggests that, in the aggregate, search engine users are visiting a smaller number of domains. This is because users have apparently grown to trust certain domains over others, and thus when a trusted domain is presented in search results, that domain is more likely to be clicked than a non-trusted domain. This trust seemingly grows as a culmination of a user's experience with a domain (and with search engines and the web at large) from making many queries and over time, and the user is more likely to return to a domain that consistently produces higher quality content for future queries (and especially related queries)—a process that is very similar to the formation of brand loyalty discussed above. Moreover, this trend provides additional evidence that users develop preferences for certain domains and become less likely to explore new or less-reliable domains, and thus the “clicked web” is shrinking in relation to the growing size of the web.

By accumulating these domain-based user preferences, an ordering of domains can be constructed that reflects these user preferences as a surrogate for (or, perhaps more accurately, a new form of) document relevance. For certain implementations, domain trust might be measured by counting the number of clicks the domain receives from a collection of query+URL pairs. However, two possible weaknesses with this approach may include (a) position bias, a factor that affects click activity, and (b) the clicks from head queries, which may dwarf signals coming from other queries. Nevertheless, this approach may produce high-quality results under certain conditions.

For alternative implementations disclosed herein, another approach to measuring domain trust that corrects for position bias and balancing signals from head and tail queries is the “ClickSkip” method of using both clicks and skips for assessing query+URL pairs, albeit here adapted for specific use with measuring domain trust.

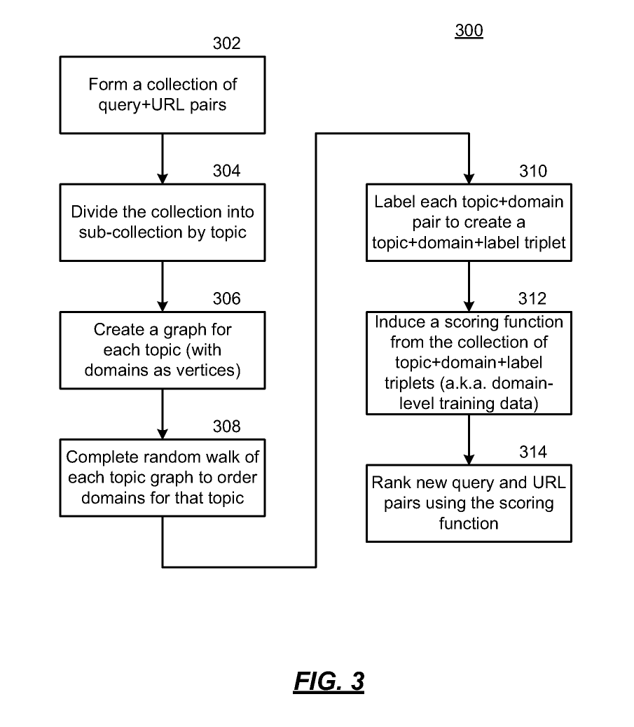

FIG. 3 is a process flow diagram of a method 300, representative of several implementations disclosed herein, for measuring domain trust based on ClickSkip data. In the figure, and at 302, a collection of query+URL pairs is formed. At 304, the collection of query+URL pairs is divided into sub-collections by topic (category) utilizing existing methods for query categorization to group the queries into predefined topics where each topic is representative of its sub-collection of queries. Topics may be coarse grain, for example, all commerce queries, or may be finer grain such as digital camera queries.

At 306, a directed graph is created for each topic where the vertices are the domains (instead of URLs in the typical application of ClickSkip) and the directed edges between the domains are weighted based on the number of users who clicked on documents in one domain and skipped documents in the other domain (as a measure of relative domain trust between the two domains).

At 308, a random walk on each topic graph is completed to create an ordering of the domains for that topic. This final ordering is then used as the basis for automatically generating training data. Specifically, at 310, each pairing of a topic and domain (topic+domain) is labeled (e.g., perfect, excellent, good, fair, bad, etc.) based on how much that particular domain is “preferred” for that particular topic in the pairing. This labeling is performed by automated means using the aggregate number of clicks (or clicks and skips) for that domain within that topic (discussed in more detail below) to generate topic+domain+label triplets that, at step 312, are provided to a machine learning algorithm to induce (or “learn”) a domain-based scoring function.

For certain implementations, the automated labeling means 310 and the scoring function 312 are the same components 204 and 206 respectively of FIG. 2, that is, these topic-domain-label triplets are indistinguishable from the query-URL-label triplets as processed by the automated labeling means 310 (and 204 of FIG. 2) and the scoring function 312 (and 206 of FIG. 2). At 314, the scoring function is used to determine scores for new query and URL pairs, namely the search results returned by a search engine in response to a user query.

Certain implementations disclosed herein are directed to creating training data for tail queries that first use the search engine to find search results that are somewhat relevant to user query and then rank these search results according to the domains (and the associated domain trust) of the URLs comprising the search results. In so ordering the results, in an implementation, this technique ignores everything else about the URL, its corresponding document (and its contents), and any other signals typically used to sort the results, and instead uses the modest relevance provided by the search engine (as reflected in the URLs comprising the returned results) along with the domains represented by the search results to order the search results by relevance more effectively than the search engine results could otherwise be ordered using other known methods.

Specific implementations may also use one or two measures of domain trust just using the number of clicks and/or using ClickSkip. In one implementation, labels may be created by applying one-dimensional k-means clustering of the number of clicks (called Clicks+Cluster). In another implementation, labels may be created using a ClickSkip approach by determining the linear ordering of domains induced by ClickSkip rank, and then overlaying the ClickSkip graph on this ordering to find ordered cuts that maximize, for the entire graph, the number of forward edges minus the number of backward edges (referred to as the Maximum Ordered Partition or MOP). This technique may be referred to as ClickSkipRank+MOP.

In an implementation, MOP may be found via a dynamic programming algorithm where the ClickSkip graph is used as the input and the resulting output is, for each query category, domains (which, again, were derived from the inputted URLs) and labels (e.g., one of perfect, excellent, good, fair, or bad, which are collectively referred to as PEGFB). This category-domain-label output is then converted into training data (similar in form to query+URL+label training data) by identifying the category of the query, identifying the domain of the URL, and then returning the associated label.

A search engine employing a ranking method of the implementations disclosed herein can efficiently and cost-effectively produce results comparable to a human-maintained categorized system (if not better). Moreover, for certain alternative implementations, a web crawler might explore the web and create an index of the web content as well as a directed graph of nodes corresponding to the structure of hyperlinks, and the nodes of this graph (corresponding to documents on the web) are then ranked according to domain trust as described above in connection with the various implementations disclosed herein.

Domain trust may have other implications for search engines. For example, existing user browsing and click models typically only use relevance and position to predict click probability, whereas the existence of domain trust suggests that user decisions to click or skip may be more complex—that is, a user's past experience with a domain could influence that user's decision as to whether a page will be clicked or skipped. This contrasts sharply with prior models where it is assumed that future search behavior is not influenced by past search experience, and thus click models that utilize domain trust would provided improved results.

Another use of domain trust is to create features that could be used to improve ranking functions. Such features could be category specific, or may be computed at a more aggregate level. Thus, the addition of domain trust as a new ranking feature (or parameter) could yield further improvements to relevance determinations and search engine scoring techniques.

Domain trust may also impact the search engine user experience. For example, domain names could appear more prominently in search results, and the relative importance and diversity of domains could be considered when generating query refinements and/or presenting search results (i.e., the “top” results from among the larger body of potential results).

Domain trust may also play a role in advertising such as, for example, the use of advertiser domain trust in improving ad ranking algorithms for sponsored search, or to provide better contextual and/or display advertising. Domain trust may also impact how sponsored search auctions are conducted, as the expected click-through rates of the advertisers is a variable in calculating the amount advertisers are willing to pay to sponsor searches.

In addition, domain trust may play a role in eliminating spam search results. Recently, many search queries surface URLs that appear to match the query, but in fact are spam, created for a variety of reasons such as installing malware, attracting advertising clicks, etc. Disreputable domains, i.e., those with low trust values, could be filtered from search results to reduce the incidence of spam.

FIG. 4 shows an exemplary computing environment in which example implementations and aspects may be implemented. The computing system environment is only one example of a suitable computing environment and is not intended to suggest any limitation as to the scope of use or functionality. Numerous other general purpose or special purpose computing system environments or configurations may be used. Examples of well known computing systems, environments, and/or configurations that may be suitable for use include, but are not limited to, personal computers (PCs), server computers, handheld or laptop devices, multiprocessor systems, microprocessor-based systems, network personal computers, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 4, an exemplary system for implementing aspects described herein includes a computing device, such as computing device 400. In its most basic configuration, computing device 400 typically includes at least one processing unit 402 and memory 404. Depending on the exact configuration and type of computing device, memory 404 may be volatile (such as random access memory (RAM)), non-volatile (such as read-only memory (ROM), flash memory, etc.), or some combination of the two. This most basic configuration is illustrated in FIG. 4 by dashed line 406.

Computing device 400 may have additional features/functionality. For example, computing device 400 may include additional storage (removable and/or non-removable) including, but not limited to, magnetic or optical disks or tape. Such additional storage is illustrated in FIG. 4 by removable storage 408 and non-removable storage 410.

Computing device 400 typically includes a variety of computer readable media. Computer readable media can be any available media that can be accessed by device 400 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 404, removable storage 408, and non-removable storage 410 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 400. Any such computer storage media may be part of computing device 400.

Computing device 400 may contain communications connection(s) 412 that allow the device to communicate with other devices. Computing device 400 may also have input device(s) 414 such as a keyboard, mouse, pen, voice input device, touch input device, etc. Output device(s) 416 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for generating training data in a search engine, the method comprising:
forming a collection of query and uniform resource locator (URL) pairings;
identifying a plurality of domains in the collection corresponding to the URL pairings; and
labeling each domain from among the plurality of domains present in the collection.

2. The method of claim 1, further comprising dividing the collection into a plurality of sub-collections by topic.

3. The method of claim 2, wherein identifying comprises identifying a plurality of domains present in at least one of the sub-collections.

4. The method of claim 3, wherein labeling comprises labeling each domain from among the plurality of domains present in the at least one sub-collection.

5. The method of claim 4, further comprising inducing a scoring function based on the plurality of domains, the topic, and the labeling.

6. The method of claim 2, further comprising creating a topic graph for at least one sub-collection from among the plurality of sub-collections, the topic graph comprising:
a plurality of vertices, wherein each vertex corresponds to a domain in the sub-collection; and
a plurality of edges, wherein each edge connects two vertices from among the plurality of vertices, and wherein each edge is weighted corresponding to activity between the two vertices the edge connects.

7. The method of claim 6 wherein labeling comprises making ordered cuts that maximize, for the entire graph, the number of forward edges minus the number of backward edges.

8. The method of claim 6, further comprising completing a random walk of the topic graph to order the domains corresponding to the vertices.

9. The method of claim 6, wherein the activity corresponds to user clicks.

10. The method of claim 6, wherein the activity corresponds to user clicks and skips.

11. The method of claim 1, wherein the collection of query and URL pairings comprises query+URL pairs from a search engine click log.

12. The method of claim 11, wherein the collection of query and URL pairings further comprises click data from the search engine click log.

13. The method of claim 12, wherein the collection of query and URL pairings further comprises skip data from the search engine click log.

14. A system for ranking search results comprising a plurality of URLs generated by a search engine in response to a query, the system comprising:
a subsystem for determining if the query is a tail query;
a subsystem for measuring a domain trust for each domain corresponding to each URL from among the plurality of URLs comprising search results for the tail query; and
a subsystem for ranking each URL from among the plurality of URLs comprising search results to the tail query in accordance with its measured domain trust.

15. The system of claim 14 further comprising a subsystem for identifying a topic corresponding to the tail query used by the search engine to generate the search results, wherein the measuring comprises measuring domain trust based on the topic for each domain corresponding to each URL from among the plurality of URLs comprising search results for the tail query.

16. The system of claim 14, further comprising a subsystem for receiving search results from a search engine.

17. The system of claim 14 wherein, for the tail query, each domain portion of each URL from among the plurality of URLs is provided for display to a user differently from each non-domain portion of each URL.

18. A computer-readable medium comprising computer readable instructions for ranking search results using domain trust, the computer-readable instructions comprising instructions that:
identify the domain trust for each domain corresponding to each of a uniform resource locator (URL) comprising the search results; and
rank each URL comprising the search results according to its domain trust.

19. The computer-readable medium of claim 18, further comprising instructions that identify a topic for the query, wherein identifying the domain trust is based on the topic.

20. The computer-readable medium of claim 18, further comprising instructions that utilize a set of domain based training data to induce the creation of a domain-based ranking function.
